(19) United States
(12) Patent Application Publication
(10) Pub. No.: US 2012/0150342 A1
(43) Pub. Date: Jun. 14, 2012

(54) SYSTEM AND METHOD FOR PROCESSING DELIVERY ITEMS

(75) Inventors: Jae Gwan SONG, Daejeon (KR); Dong-Gil Na, Daejeon (KR); JaeMin Seol, Daejeon (KR); Hoon Jung, Daejeon (KR); Jong Heung Park, Daejeon (KR)

(73) Assignee: ELECTRONICS AND TELECOMMUNICATIONS RESEARCH INSTITUTE, Daejeon (KR)

(21) Appl. No.: 13/311,915

(22) Filed: Dec. 6, 2011

(30) Foreign Application Priority Data
Dec. 7, 2010 (KR) 10-2010-0124511

(51) Int. Cl. G06F 7/00; G06Q 30/00

(52) U.S. Cl. 700/226; 235/385

(57) ABSTRACT

Disclosed herein is a system and method for processing delivery items. The system for processing delivery items may include: a delivery item transfer device which transfers a delivery item put into the system and measures at least one delivery item information selected from the group consisting of an image, a bar code, an address, a shape, a volume, and a weight of the delivery item; a control device which generates sorting information for each delivery zone and delivery route information, which are required to deliver the delivery items, and provides the generated sorting information for each delivery zone or delivery route information and the at least one delivery item information; and a robot device which loads the delivery item into a corresponding loading container by controlling a robot based on the generated sorting information for each delivery zone or delivery route information and the at least one delivery item information.

### CROSS-REFERENCE TO RELATED PATENT APPLICATION

This application claims the benefit of Korean Patent Application No. 10-2010-0124511, filed on Dec. 7, 2010, in the Korean Intellectual Property Office, the disclosure of which is incorporated herein in its entirety by reference.

### BACKGROUND OF THE INVENTION

1. Field of the Invention

The present invention relates to a process for processing delivery items and, more particularly, to a system and method for processing delivery items, which can automatically perform a process of sorting delivery items for each delivery zone and a process of sorting delivery routes using a robot.

2. Description of the Related Art

In general, according to a system for processing mail items, the mail items are sorted for each delivery zone of a postman, delivery routes of the mail items are sorted by the postman, and then the mail items are delivered to recipients.

FIG. 1 is a conceptual diagram showing a typical process for processing mail items.

Referring to FIG. 1, when a mail clerk visits a customer to pick up a mail item or when a sender 11 visits a receiving office 12 (or a dispatch mail center 13) to send the mail item, the received mail items are transmitted to the mail center 13, sorted for each delivery zone at the mail center 13, and then exchanged for each delivery zone at an exchange center 15.

Then, the mail items exchanged for each delivery zone are transmitted to an arrival mail center 16, sorted for each local office at the arrival mail center 16, and then transported to a delivery office 17. The mail items transported to the delivery office 17 are sorted again for each delivery zone of the postman, the delivery routes are sorted manually by the postmen based on a delivery order, and then the mail items are delivered to each recipient 18 at a home or office along the sorted delivery route.

In order to increase vehicle transportation efficiency during the process for processing mail items, the mail items may be directly exchanged 14 between the mail centers 13 and 16 without passing through the exchange center 15.

During the conventional process for processing mail items as shown in FIG. 1, the process of sorting the mail items for each delivery zone and for each postman at the delivery office (or distributing office) is mainly performed manually depending on the experience of the postman. Thus, the working time is increased and the mail items may be missorted, thereby increasing the processing cost.

Meanwhile, ordinary parcels are processed by a process similar to the above-described process for processing mail items.

FIG. 2 is a conceptual diagram showing a typical process for processing courier items.

Referring to FIG. 2, when a sender 21 who wants to send a courier item requests a call center 22 to pick up the parcel, a parcel collector visits a place where the sender 21 is located to pick up the parcel. The picked-up parcels are collected in a service office 23 and then transmitted to a dispatch hub terminal 24 for interzonal transportation. Then, the parcels are sorted for each delivery zone and transported to a sub-terminal 25 located in each zone. At the sub-terminal 25 in each zone, the parcels are sorted for each service office 26 having jurisdiction over a segmented zone, and when the parcels are sent to a courier agency having jurisdiction over a further segmented zone, a courier delivery man receives the courier items corresponding to his delivery zone, sorts the courier items in a delivery order, and then delivers the courier items to each recipient 27.

In the case of the process for processing courier items as shown in FIG. 2, the dependence on manual operations is much larger than the process for processing mail items shown in FIG. 1. That is, at the courier service office or service agency, each courier delivery man manually sorts the delivery routes of the courier items that he will deliver, and thus this process of sorting the delivery routes takes considerable time.

Moreover, since the process of sorting the courier items for each delivery zone or the process of sorting the delivery routes depends on manual operations, the courier items may be missorted, which thus increases the processing cost as well as the delivery time.

### SUMMARY OF THE INVENTION

The present invention has been made in an effort to solve the above-described problems associated with prior art, and an object of the present invention is to provide a system for processing delivery items, which can reduce the time required to process the delivery items, thereby reducing the processing cost of the delivery items.

Moreover, another object of the present invention is to provide a method for processing delivery items, which can reduce the time required to process the delivery items, thereby reducing the processing cost of the delivery items.

According to an aspect of the present invention to achieve the above object of the present invention, there is provided a system for processing delivery items, the system comprising: a delivery item transfer device which transfers a delivery item put into the system and measures at least one delivery item information selected from the group consisting of an image, a bar code, an address, a shape, a volume, and a weight of the delivery item; a control device which generates sorting information for each delivery zone and delivery route information, which are required to deliver the delivery items, and provides the generated sorting information for each delivery zone or delivery route information and the at least one delivery item information; and a robot device which loads the delivery item into a corresponding loading container by controlling a robot based on the generated sorting information for each delivery zone or delivery route information and the at least one delivery item information.

The delivery item transfer device may comprise: a bar code reader which reads bar code information on the delivery item and provides the read bar code information to the control device; an image capturer which captures an image of the delivery item; a character recognizer which recognizes address information on the delivery item by processing the captured image and provides the recognized address information to the control device; a shape/volume detector which measures the shape and volume of the delivery item and provides the measurement value to the control device; and a weight detector which measures the weight of the delivery item.

The delivery item transfer device may comprise a delivery item position controller which aligns the position of the delivery item.

The control device may comprise: a postal code database in which postal code information is stored; a delivery route database in which delivery route information based on addresses is stored; a sorting information generator which obtains postal code information corresponding to the bar code information by referring to the postal code database and generates the sorting information for each delivery zone; and a delivery route information generator which generates delivery route sorting information corresponding to the address information on the delivery item.

The robot device may comprise: a palletizer controller which controls the operation of the robot based on the at least one delivery item information provided from the control unit; and a delivery item pickup which picks up the delivery item and loads the delivery item into a corresponding loading container in response to the control of the palletizer controller.

According to another aspect of the present invention to achieve the above object of the present invention, there is provided a method for processing delivery items implemented in a system for processing delivery items, the system comprising a delivery item transfer device, a control device, and a robot device, and the method comprising the steps of: reading, at the delivery item transfer device, bar code information on a delivery item put into the system; measuring, at the delivery item transfer device, physical information on the delivery item; generating, at the control device, sorting information for each delivery zone of the delivery items based on the read bar code information; and loading, at the robot device, the delivery item into a corresponding loading container by controlling a robot based on the sorting information for each delivery zone and the physical information on the delivery item.

The step of reading the bar code information on the delivery item put into the system may comprise the steps of: detecting, at the delivery item transfer device, whether the delivery item is put into the system; and aligning, at the delivery item transfer device, the position of the delivery item put into the system, thereby reading the bar code information on the delivery item.

In the step of measuring the physical information on the delivery item, the delivery item transfer device may measure at least one physical information selected from the group consisting of a shape, a volume, and a weight of the delivery item.

In the step of generating the sorting information for each delivery zone of the delivery items based on the read bar code information, a postal code corresponding to the read bar code information may be extracted from a predetermined postal code database, thereby generating the sorting information for each delivery zone of the delivery items.

In the step of loading the delivery item into the corresponding loading container, the robot device may pick up the delivery item by controlling the pickup of the robot based on the physical information and then load the delivery item into the corresponding loading container based on loading container information as the sorting information for each delivery zone of the delivery items.

According to still another aspect of the present invention to achieve the above object of the present invention, there is provided a method for processing delivery items implemented in a system for processing delivery items, the system comprising a delivery item transfer device, a control device, and a robot device, and the method comprising the steps of: capturing, at the delivery item transfer device, an image of a delivery item put into the system; obtaining, at the delivery item transfer device, address information on the delivery item by processing the image of the delivery item; measuring, at the delivery item transfer device, physical information on the delivery item; generating, at the control device, delivery route information on the delivery item based on the address information on the delivery item; and loading, at the robot device, the delivery item into a corresponding loading container by controlling a robot based on the delivery route information and the physical information on the delivery item.

The step of capturing the image of the delivery item put into the system may comprise the steps of: detecting, at the delivery item transfer device, whether the delivery item is put into the system; and aligning, at the delivery item transfer device, the position of the delivery item put into the system, thereby capturing the image of the delivery item.

In the step of measuring the physical information on the delivery item, the delivery item transfer device may measure at least one physical information selected from the group consisting of a shape, a volume, and a weight of the delivery item.

In the step of generating the delivery route information on the delivery item based on the address information on the delivery item, order information corresponding to the address information on the delivery item may be extracted from a predetermined delivery route database, thereby generating the delivery route information on the delivery item.

In the step of loading the delivery item into the corresponding loading, the robot device may pick up the delivery item by controlling the pickup of the robot based on the physical information and then load the delivery item into the corresponding loading container based on the order information as the delivery route information on the delivery item.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram showing a typical process for processing mail items;

FIG. 2 is a conceptual diagram showing a typical process for processing courier items;

FIG. 3 is a conceptual diagram showing a system for processing delivery items in accordance with an exemplary embodiment of the present invention;

FIG. 4 is a block diagram showing the configuration of a system for processing delivery items in accordance with an exemplary embodiment of the present invention;

FIG. 5 is a flowchart showing a simple sorting process for delivery items in a method for processing delivery items in accordance with another exemplary embodiment of the present invention; and

FIG. 6 is a flowchart showing a delivery route sorting process for delivery items in a method for processing delivery items in accordance with another exemplary embodiment of the present invention.

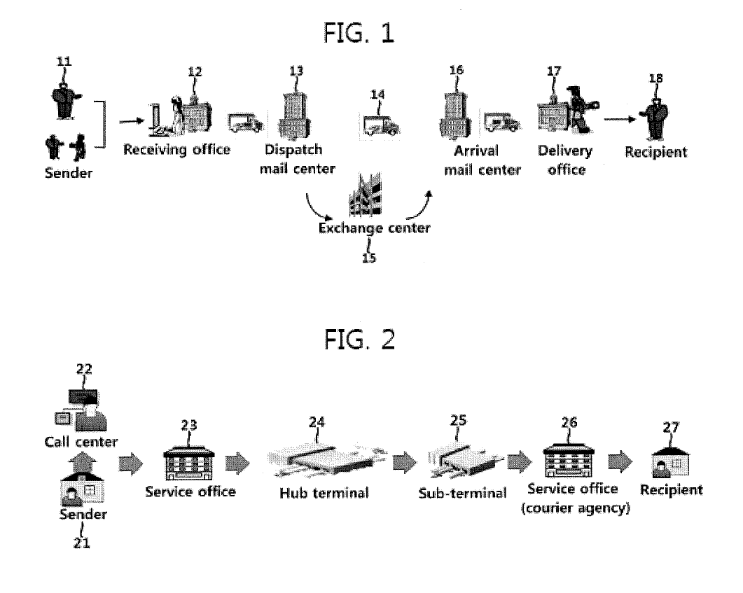

### DETAILED DESCRIPTION OF THE INVENTION

While the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings. Like reference numerals in the drawings denote like elements, and thus repeated descriptions will be omitted.

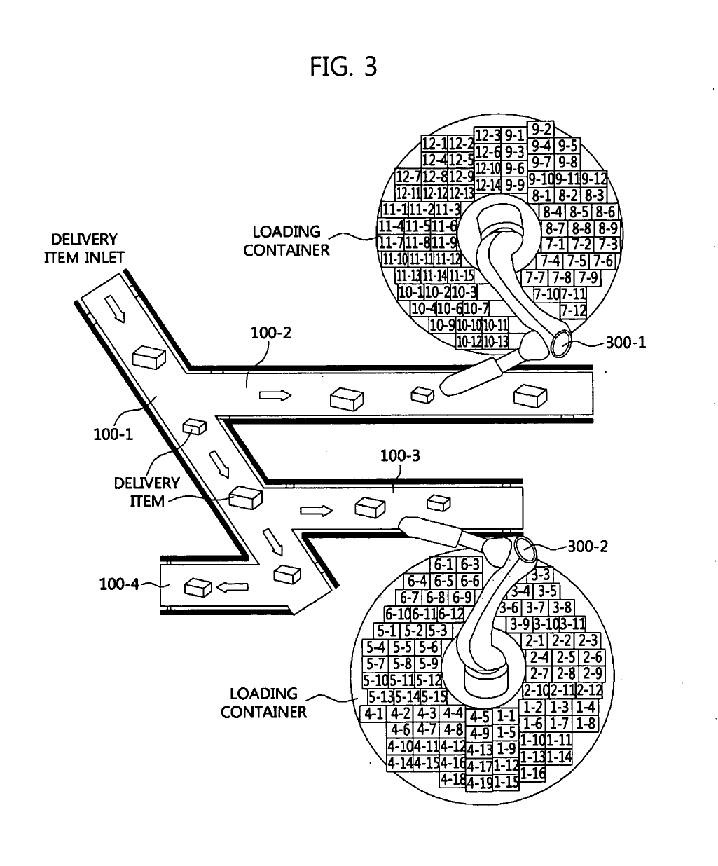

FIG. 3 is a conceptual diagram showing a system for processing delivery items in accordance with an exemplary embodiment of the present invention, which comprises a conveyor device for transferring delivery items, a robot device, and loading containers in which the delivery items are loaded by the robot device. Here, the conveyor device and the robot device may be singular or plural in number depending on the delivery item processing environment, and the number of loading containers may be flexibly adjusted depending on the quantity of delivery items.

The configuration and operation of the system for processing delivery items in accordance with an exemplary embodiment of the present invention will now be described with reference to FIG. 3. When delivery items are sequentially put through a delivery item inlet provided on one side of a first conveyor device 100-1, the delivery items move along the first conveyor device 100-1 and are divided into a second conveyor device 100-2 and a third conveyor device 100-3 depending on the destinations of the delivery items. Here, a first robot device 300-1 and a second robot device 300-2 pick up the delivery items transferred by the second conveyor device 100-2 and the third conveyor device 100-3 and load the delivery items into the corresponding loading containers, respectively.

Here, when the time required for the first robot device 300-1 and the second robot device 300-2 to load the delivery items into the loading containers is longer than the time required for the corresponding conveyor devices to supply the delivery items, or in the event of an error in information on the delivery item, the corresponding delivery items may be addressed to a fourth conveyor device 100-4 and processed manually or may be returned to the delivery item inlet of the first conveyor device 100-1.

The system for processing delivery items in accordance with an exemplary embodiment of the present invention as shown in FIG. 3 can be applied to a process of sorting delivery items, which have arrived at a delivery office (or distributing office) or at a service office (or service agency) from a mail center or hub center, for each delivery man (or for each delivery zone) or a process of sorting delivery routes for the delivery items, thereby replacing the manual process, which has been conventionally performed by the delivery man.

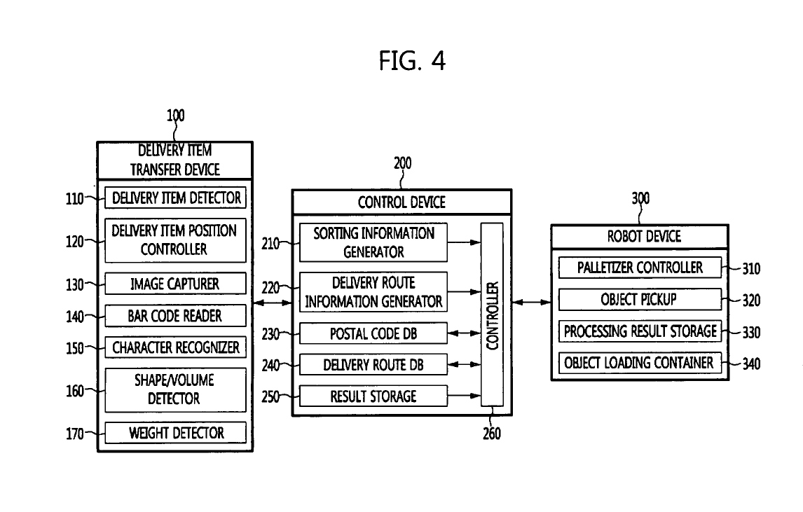

FIG. 4 is a block diagram showing the configuration of a system for processing delivery items in accordance with an exemplary embodiment of the present invention.

Referring to FIG. 4, a system for processing delivery items in accordance with an exemplary embodiment of the present invention may generally comprise a delivery item transfer device 100, a control device 200, and a robot device 300.

The delivery item transfer device 100 transfers delivery items put into the system, measures at least one delivery item information selected from the group consisting of an image, a bar code, an address, a shape, a volume, and a weight of the delivery item, and provides the measured information to the control device 200.

The control device 200 performs a process of sorting delivery items for each delivery zone and a process of sorting delivery routes based on the information provided from the delivery item transfer device 100 to generate simple sorting information and delivery route sorting information and provides the at least one information provided from the delivery item transfer device 100 and loading container information corresponding to the simple sorting information and the delivery route sorting information to the robot device 300.

The robot device 300 loads the delivery item into a corresponding loading container by controlling a robot based on the information provided from the control device 200.

The delivery item transfer device 100 may be configures as a conveyor device shown in FIG. 3, for example, and may comprise a delivery item detector 110, a delivery item position controller 120, an image capturer 130, a bar code reader 140, a character recognizer 150, a shape/volume detector 160, and a weight detector 170. Hereinbelow, a description will be given of an example in which the delivery item transfer device 100 is implemented as a conveyor device for convenience of explanation.

The delivery item detector 110 serves to detect whether a delivery item is put into the conveyor device, and the delivery item position controller 120 serve to guide the delivery item to a predetermined position to accurately measure the volume and shape of the delivery item, thereby calculating a measurement value.

The image capturer 130 captures an image of the delivery item for character recognition and provides the captured image of the delivery item to the character recognizer 150. The bar code reader 140 reads bar code information printed on the delivery item and provides the read bar code information to the control device 200. Moreover, the character recognizer 150 recognizes address information printed on the delivery item based on the image of the delivery item provided from the image capturer 130 and provides the recognized address information to the control device 200.

The shape/volume detector 160 measures the volume and shape of the delivery item, and the weight detector 170 measures the weight of the delivery item. Here, the measured delivery item information on the shape, volume, and weight is provided to the control device 200.

The control device 200 may comprises a sorting information generator 210, a delivery route information generator 220, a postal code database 230, a delivery route database 240, a result storage 250, and a controller 260.

The sorting information generator 210 searches for the postal code database 230 and extracts information corresponding to the read bar code information provided from the bar code reader 140, thereby generating simple sorting information to sort the delivery items for each delivery zone. Here, the simple sorting information may be a postal code.

The delivery route information generator 220 generates delivery route sorting information to sort the delivery routes of the delivery items by referring to the delivery route database 240 based on the address information as a result of the character recognition provided from the character recognizer 150. Here, the delivery route information may be delivery order information corresponding to the delivery address of the delivery item.

Postal information for extracting a postal code is stored in the postal code database 230, and the delivery route information used to determine the order of address information recognized from the delivery items during the delivery route sorting process is stored in the delivery route database 240.

The processing result according to the operation or process of the control device 200 is stored in the result storage 250. The simple sorting information and/or the delivery route sorting information, for example, may be stored in the result storage 250.

The controller 260 controls the overall operation of the control device 200 and transmits and receives information to and from the delivery item transfer device 100 and the robot device 300 or exchanges information with an external system. Here, the controller 260 may provide the simple sorting information and the delivery route sorting information directly to the robot device 300 or may provide loading container information on the delivery item corresponding to the simple sorting information and the delivery route sorting information to the robot device 300.

The robot device 300 may comprise a palletizer controller 310, an object pickup 320, a processing result storage 330, and an object loading container 340.

The palletizer controller 310 controls the overall operation of a robot based on the control information (such as the simple sorting information and delivery route sorting information or robot control information) provided from the control device 200. The object pickup 320 is installed on an arm of the robot and serves to pick up or drop off the delivery item in response to the control of the palletizer controller 310.

A series of processing results of operations performed by the robot are stored in the processing result storage 330, and the delivery items sorted by the robot are loaded into the object loading container 340.

The above-described system for processing delivery items in accordance with an exemplary embodiment of the present invention performs a simple sorting function to simply sort the delivery items for each delivery zone and a delivery route sorting function to sort the delivery routes of the delivery items for each delivery zone based on the delivery order of the delivery man.

Next, a method for processing delivery items in accordance with another exemplary embodiment of the present invention, which is implemented in the above-described system for processing delivery items in accordance with an exemplary embodiment of the present invention, will be described in more detail with respect to the drawings.

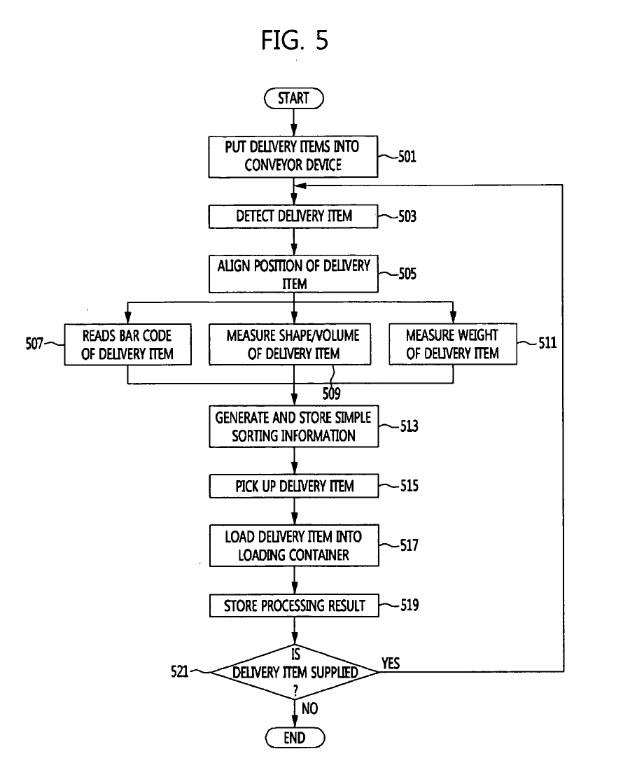

FIG. 5 is a flowchart showing a simple sorting process for delivery items in a method for processing delivery items in accordance with another exemplary embodiment of the present invention.

Referring to FIG. 5, when delivery items are sequentially put into the conveyor device (step 501), the delivery item detector detects the delivery item put into the conveyor device (step 503), and the delivery item position controller aligns the position of the delivery item transferred by the conveyor device (step 505) such that the information on the delivery item can be accurately captured. By the above-described alignment the positions of the delivery items, the delivery items can be transferred on the conveyor device in a consistent manner.

Then, when the delivery items whose positions are aligned are transferred by the conveyor device, the bar code reader installed at the conveyor device reads the bar code printed on the delivery item (step 507), the shape/volume detector calculates the volume of the delivery item by measuring the width, length, and height of the delivery item (step 509), and the weight detector measures the weight of the delivery item (step 511).

Steps 507 to 511 are performed while the delivery item is being transferred by the conveyor device, and the result measured in each step may be transmitted to the control device shown in FIG. 4. Moreover, steps 507 to 511 may be repeatedly performed as long as the delivery items are put into the conveyor device, and if the delivery item is not put into the conveyor device and a predetermined time elapses, the operation of the system for processing delivery items may be stopped.

As mentioned above, the control device of the system for processing delivery items obtains bar code information on the delivery item, searches for the postal code database to generate simple sorting information on the delivery item for each delivery zone, stores the generated simple sorting information in the result storage (step 513), and transmits the information on the loading container, into which the corresponding delivery item is loaded, and the information on the size, volume, and weight to the robot device.

The palletizer controller of the robot device provides control information required to pick up the corresponding delivery item to the delivery item pickup based on the information on the size, volume and weight of the corresponding delivery item provided from the control device such that the delivery item pickup may pick up the corresponding delivery item (step 515) and load it into the corresponding loading container (step 517). Here, the delivery item pickup loads the delivery item into the corresponding loading container among a plurality of loading containers disposed around the robot device based on the loading container information provided from the control device.

Then, the robot device stores the processing result of the corresponding delivery item in the processing result storage (step 519).

Next, the system for processing delivery items determines whether the delivery items are continuously put into the conveyor device (step 521) and, if it is determined that the delivery item is not put into the conveyor device for more than a predetermined time, terminates the process for processing delivery items. Here, the control device of the system for processing delivery items may determine whether the delivery item is put into the conveyor device based on the detection information provided from the delivery item detector.

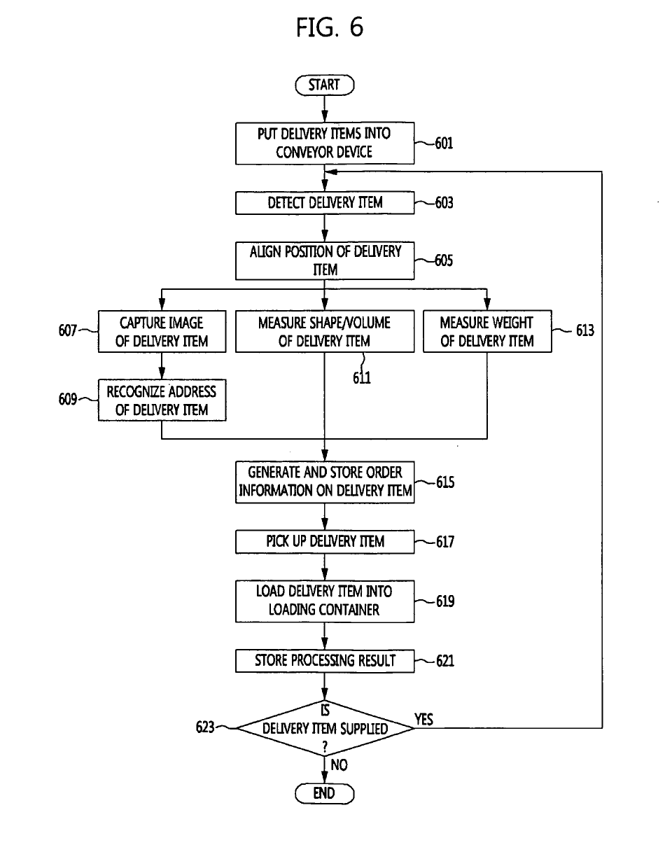

FIG. 6 is a flowchart showing a delivery route sorting process for delivery items in the method for processing delivery items in accordance with another exemplary embodiment of the present invention.

During the simple sorting process, the delivery items are sorted for each specific delivery zone regardless of the order, and thus the complexity of the sorting process is relatively low. However, during the delivery route sorting process, the delivery items should be sorted depending on the delivery order of the delivery man for a specific zone, and thus the complexity of the delivery route sorting process is higher than the simple sorting process of the delivery items.

Referring to FIG. 6, when delivery items are sequentially put into the conveyor device (step 601), the delivery item detector detects the delivery item put into the conveyor device (step 603), and the delivery item position controller aligns the position of the delivery item transferred by the conveyor device (step 605) such that the information on the delivery item can be accurately captured. By the above-described alignment the positions of the delivery items, the delivery items can be transferred on the conveyor device in a consistent manner.

Then, when the delivery item whose position is aligned reaches the front of the image capturer while being transferred by the conveyor device, the image capturer captures an image of the delivery item and transmits the image to the character recognizer (step 607), and the character recognizer recognizes the address of the delivery item by processing the captured image (step 609). At the same time, the shape/volume detector calculates the volume of the delivery item by measuring the width, length, and height of the delivery item (step 611), and the weight detector measures the weight of the delivery item (step 613).

Steps 607 to 611 are performed while the delivery item is being transferred by the conveyor device, and the result measured in each step may be transmitted to the control device shown in FIG. 4. Moreover, steps 607 to 611 are repeatedly performed as long as the delivery items are put into the conveyor device.

As mentioned above, the control device of the system for processing delivery items obtains address information on the delivery item, generates order information on the delivery item from the delivery order by referring to the delivery route database based on the obtained address information, stores the generated order information in the result storage (step 615), and transmits the order information together with the information on the size, volume, and weight to the robot device.

The palletizer controller of the robot device provides control information required to pick up the corresponding delivery item to the delivery item pickup based on the information on the size, volume and weight of the corresponding delivery item provided from the control device such that the delivery item pickup may pick up the corresponding delivery item (step 617) and load it into the corresponding loading container (step 619). Here, the delivery item pickup loads the delivery item into the corresponding loading container among a plurality of loading containers disposed around the robot device based on the order information provided from the control device.

Then, the robot device stores the processing result of the corresponding delivery item in the processing result storage (step 621).

Next, the system for processing delivery items determines whether the delivery items are continuously put into the conveyor device (step 623) and, if it is determined that the delivery item is not put into the conveyor device for more than a predetermined time, terminates the process for processing delivery items. Here, the control device of the system for processing delivery items may determine whether the delivery item is put into the conveyor device based on the detection information provided from the delivery item detector.

As described above, according to the system and method for processing delivery items, the process of sorting the delivery items for each delivery zone and the process of sorting the delivery routes can be automatically performed by obtaining the bar code information on the delivery item or the address information on the delivery item, generating the simple sorting information and the delivery route sorting information on the delivery item, measuring the physical information such as the volume, size, weight, etc. of the delivery item, and then loading the delivery item in the corresponding loading container by controlling the robot based on the physical information on the delivery item and the sorting information or delivery route sorting information.

Therefore, it is possible to automate the process of sorting the delivery items for each delivery zone and the process of sorting the delivery routes, which have been performed manually by the postman or delivery man, thereby reducing the processing time.

Moreover, since the process of sorting the delivery items for each delivery zone and the process of sorting the delivery routes are automated, it is possible to prevent musculoskeletal disorders or injuries of the employees such as postman or delivery man who manually sorts the delivery items.

Furthermore, since the sorting process is automated, it is possible to store the sorting process results and statistically utilize the stored information, thereby preventing the delivery items from being missorted and improving the efficiency of the process.

In addition, it is possible to reduce the processing cost, prevent industrial accidents, and improve the quality of life of the employees in parcel and courier services in which the dependence on manual operations is very high.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A system for processing delivery items, the system comprising:
a delivery item transfer device which transfers a delivery item put into the system and measures at least one delivery item information selected from the group consisting of an image, a bar code, an address, a shape, a volume, and a weight of the delivery item;
a control device which generates sorting information for each delivery zone and delivery route information, which are required to deliver the delivery items, and provides the generated sorting information for each delivery zone or delivery route information and the at least one delivery item information; and
a robot device which loads the delivery item into a corresponding loading container by controlling a robot based on the generated sorting information for each delivery zone or delivery route information and the at least one delivery item information.

2. The system of claim 1, wherein the delivery item transfer device comprises:
a bar code reader which reads bar code information on the delivery item and provides the read bar code information to the control device;
an image capturer which captures an image of the delivery item;
a character recognizer which recognizes address information on the delivery item by processing the captured image and provides the recognized address information to the control device;
a shape/volume detector which measures the shape and volume of the delivery item and provides the measurement value to the control device; and
a weight detector which measures the weight of the delivery item.

3. The system of claim 1, wherein the delivery item transfer device comprises a delivery item position controller which aligns the position of the delivery item.

4. The system of claim 1, wherein the control device comprises:
a postal code database in which postal code information is stored;
a delivery route database in which delivery route information based on addresses is stored;
a sorting information generator which obtains postal code information corresponding to the bar code information by referring to the postal code database and generates the sorting information for each delivery zone; and
a delivery route information generator which generates delivery route sorting information corresponding to the address information on the delivery item.

5. The system of claim 1, wherein the robot device comprises:
a palletizer controller which controls the operation of the robot based on the at least one delivery item information provided from the control unit; and
a delivery item pickup which picks up the delivery item and loads the delivery item into a corresponding loading container in response to the control of the palletizer controller.

6. A method for processing delivery items implemented in a system for processing delivery items, the system comprising a delivery item transfer device, a control device, and a robot device, and the method comprising:
reading, at the delivery item transfer device, bar code information on a delivery item put into the system;
measuring, at the delivery item transfer device, physical information on the delivery item;
generating, at the control device, sorting information for each delivery zone of the delivery items based on the read bar code information; and
loading, at the robot device, the delivery item into a corresponding loading container by controlling a robot based on the sorting information for each delivery zone and the physical information on the delivery item.

7. The method of claim 6, wherein the reading the bar code information on the delivery item put into the system comprises:
detecting, at the delivery item transfer device, whether the delivery item is put into the system; and
aligning, at the delivery item transfer device, the position of the delivery item put into the system, thereby reading the bar code information on the delivery item.

8. The method of claim 6, wherein in the measuring the physical information on the delivery item, the delivery item transfer device measures at least one physical information selected from the group consisting of a shape, a volume, and a weight of the delivery item.

9. The method of claim 6, wherein in the generating the sorting information for each delivery zone of the delivery items based on the read bar code information, a postal code corresponding to the read bar code information is extracted from a predetermined postal code database, thereby generating the sorting information for each delivery zone of the delivery items.

10. The method of claim 6, wherein in the loading the delivery item into the corresponding loading container, the robot device picks up the delivery item by controlling the pickup of the robot based on the physical information and then loads the delivery item into the corresponding loading container based on loading container information as the sorting information for each delivery zone of the delivery items.

11. A method for processing delivery items implemented in a system for processing delivery items, the system comprising a delivery item transfer device, a control device, and a robot device, and the method comprising:
capturing, at the delivery item transfer device, an image of a delivery item put into the system;
obtaining, at the delivery item transfer device, address information on the delivery item by processing the image of the delivery item;
measuring, at the delivery item transfer device, physical information on the delivery item;
generating, at the control device, delivery route information on the delivery item based on the address information on the delivery item; and
loading, at the robot device, the delivery item into a corresponding loading container by controlling a robot based on the delivery route information and the physical information on the delivery item.

12. The method of claim 11, wherein the capturing the image of the delivery item put into the system comprises:
detecting, at the delivery item transfer device, whether the delivery item is put into the system; and
aligning, at the delivery item transfer device, the position of the delivery item put into the system, thereby capturing the image of the delivery item.

13. The method of claim 11, wherein in the measuring the physical information on the delivery item, the delivery item transfer device measures at least one physical information selected from the group consisting of a shape, a volume, and a weight of the delivery item.

14. The method of claim 11, wherein in the generating the delivery route information on the delivery item based on the address information on the delivery item, order information corresponding to the address information on the delivery item is extracted from a predetermined delivery route database, thereby generating the delivery route information on the delivery item.

15. The method of claim 11, wherein in the loading the delivery item into the corresponding loading, the robot device picks up the delivery item by controlling the pickup of the robot based on the physical information and then loads the delivery item into the corresponding loading container based on the order information as the delivery route information on the delivery item.
